(19) United States
(12) Patent Application Publication
(10) Pub. No.: US 2003/0192044 A1
(43) Pub. Date: Oct. 9, 2003

(54) Content filtering system and method

(76) Inventor: Robert Ames Huntsman, Boise, ID (US)

Correspondence Address: ROBERT A. HUNTSMAN, 4466 S. RIVA RIDGE WAY, BOISE, ID, 83709, US

(21) Appl. No.: 10/063,253

(22) Filed: Apr. 4, 2002

(51) Int. Cl. H04N 7/16

(52) U.S. Cl. 725/25

(57) ABSTRACT

This invention teaches a next generation system and method for filtering the content of media events such a commercial movies distributed for home viewing. A content filter, separate from the medium containing the event to be filtered, applied while such viewing occurs, is taught. In some embodiments, the content filter is controlled by a preference control device while viewing occurs, allowing the viewer to adjust the content in much the same manner that sound, volume, or color can be adjusted while watching television. Sophisticated content filters which contain multiple subfilters from a plurality of authors and which apply a plurality of editing strategies, giving the viewer far more control over the content to be viewed, are taught. Filters for a number of varied purposes are taught, including both filters for offensive content and filters to adjust the contents to suit the needs and preferences of handicapped viewers. The use of a separate content filter with commercially produced media eliminates the need to create a persistent copy of the original event, thus respecting the copyright ownership of commercially produced media events such as movies and providing a system and method for third party authors to write a variety of content filters for popular media events.

### BACKGROUND OF INVENTION

Media events, such as commercially produced movies and television programs, often have content that is offensive or otherwise objectionable to different classes of consumers who are potential viewers. If a work is totally objectionable, then the consumer simply avoids the work. Frequently, a work is objectionable only in part.

When an event is only partially objectionable, it is often desirable to present the media event in such a way that accommodates a particular viewer”s objection by filtering the content. Filtering includes eliminating or modifying viewer-specific objectionable content, and in some cases, adding content. The complete list of deletions, modifications, and additions for a particular media event is called a content filter.

A number of technologies are available to filter media content. One technology scans text encoded in the closed caption stream of television programs or movies and blocks or changes potentially offensive content based on the presence of objectionable words and phrases in the closed-caption text stream. Another technology takes commercially produced movies and produces an altered version with edited content, and makes copies of the edited movie on consumer media such as video tapes or DVD discs for distribution to a select group of consumers who find the original media event objectionable.

Unfortunately, such techniques are undesirable for at least two reasons. First, since viewer preferences vary widely, any single content filter will not suit the tastes of all viewers. Second, producing a persistent copy of the work in altered form presents a potential copyright problem, and generally requires permission from the copyright holder, which may not be feasible.

Another scheme copies an original work onto a computer hard disk, receives a filter through the internet, telephone lines, or another source, and produces a modified copy on hard disk for later viewing. This technique requires a persistent copy to be made on a hard disk, and generally requires Internet or telephone connections in order to receive the filters. Such access to the system makes it easy to improperly distribute original or modified works over the Internet or other broadband telecommunication systems.

Each of the aforementioned technologies produces a single edited version of the media event that reflects the tastes and decisions of either a human or electronic editor. If the viewer”s tastes are not reflected by any individual editor, then the viewer will likely be dissatisfied. Furthermore, viewers would often like to know about a particular instance during which editing occurs without being exposed to the offensive content. A deletion often breaks the continuity of a particular plot line, thereby disrupting the viewer”s visual experience and raising questions in the viewer”s mind. In such cases, the viewer may wish to know more about the actual instance in which editing occurred without being exposed to the edited content. Alternatively, the viewer may change his or her mind and elect to view an unmodified scene when a particular editing alteration is unacceptable.

What is needed is a system of content filtering that is easy to deploy, that accommodates a wide range of viewer tastes and preferences, and that can be adjusted to suit individual viewer preferences during the viewing process while also avoiding the copyright difficulties that may arise when making a persistent copy of an original work.

### SUMMARY OF INVENTION

The present invention solves the problems cited by teaching a novel delivery system that applies a master filter to an associated media event simultaneous to the viewing process. Unlike the prior art, in which a single filter is applied, the present invention teaches a master filter consisting of one or more subfilters. A given master filter can contain both multiple subfilters from different editors and multiple subfilters from the same editor where the subfilters edit according to different editing strategies. Each subfilter reflects the tastes and editorial decisions that a single editor applies according to a particular editing strategy. Each editing strategy reflects an attempt to meet a particular class of foreseeable objections by a particular class of viewers. A particular viewer can specify his or her personal master filtering preferences by identifying both the editorial decisions to be applied and his or her preferences with respect to one or more editors in which the viewer has confidence. The master filter is applied to an original media event during the viewing process. When a potentially objectionable scene is about to be rendered while the event is being viewed, the present invention reviews the preferences of a viewer and selects and applies the editing constraints of one or more compatible subfilters, which have been deemed to be the closest reflection of the viewer”s specified tastes. Optionally, a visual or audio indicator can be applied to subtly inform a viewer that editing has occurred. A viewer, if unsatisfied with the altered scene, may request an immediate “instant replay” by specifying different filter parameters.

In this manner, different renditions are available for the same media event. Since the filters are applied during the viewing period, the practice of making a persistent copy of the original media event is unnecessary.

### BRIEF DESCRIPTION OF DRAWINGS

FIG. 1 shows a general, high-level block diagram of the present invention.

FIG. 2 shows a more detailed block diagram of an embodiment of the present invention having a single media receiver to receive both the content filter and the unfiltered media event.

FIG. 3 shows an alternate embodiment of the present invention in which the content filter and the unfiltered media event have separate receivers.

FIG. 4 shows a block diagram of a preferred embodiment of the present invention.

FIG. 5 shows a block diagram that illustrates how the present invention allows viewer preferences and various subfilters to be used to select a particular editing alteration simultaneous to viewing.

### DETAILED DESCRIPTION

The present invention solves the problems cited by teaching a novel system for delivering content-filtered media events to a viewer. The new delivery system teaches the application of a novel master filter to the associated media event simultaneous to the viewing period. The master filter contains one or more subfilters, described in detail below. During the period of viewing, the delivery system allows the user to apply and adjust the master filter to deploy a meaningful combination of subfilters in order to suit the tastes and preferences of the viewer. A viewer is thus provided with visual and audio controls to allow him or her to manage, monitor, and adjust the filtering simultaneous to viewing. Also, a viewer is not limited to the editorial decisions of any single editor, nor is a viewer limited to a single editing strategy. The present invention teaches optional display icons that provide a viewer with subtle notification that filtering is being applied. This notification gives a viewer the opportunity to rewind and review a filtered segment with different filtering parameters. Furthermore, a viewer can determine more information about the nature of a particular instance in which editing takes place without being exposed to potentially offensive content. For example, if during the viewing process, an icon indicates that editing has occurred, a viewer may use a remote control to pause the media event so that he or she can read a text description indicating the nature of the alteration, such as notification that a gruesome murder scene had been removed. Subsequently, the viewer could either resume viewing the movie or choose to watch the unedited murder scene. Or, if a suitable alternate subfilter has been provided, the viewer may watch the murder scene as alternatively edited.

The preferred embodiment is deployed as an enhanced DVD player. In the preferred embodiment, the targeted media events are movies distributed on digital-versatile disc (DVD) media. DVD media is well known in the art. When deploying the preferred embodiment of the invention, movie titles are distributed as a 2 disc set. The first disc is the unfiltered movie as distributed by the copyright owner. The second disc contains a master filter as taught by the present invention for the specific unfiltered movie. The enhanced DVD player accepts both the filter disc and the unfiltered movie disc.

[New paragraph] Preferably, the filter disc is loaded first. If an unfiltered media title is inserted without a corresponding filter disc, then the enhanced DVD player will play the unfiltered title disc as in the prior art. In the preferred embodiment, for a particular title, the user loads the content filter disc and the enhanced DVD player reads and records the filtering information, which is typically small as contrasted with the associated media event. After reading and recording the master filter, the enhanced DVD player ejects the master filter disc. The DVD title is then loaded into the enhanced DVD player for filtered viewing. As the title is being played, the content filter is applied according to a preset algorithm reflecting the viewer”s preferences. In the preferred embodiment, the settings of the master filter can be modified and adjusted by the viewer at any time during viewing via the remote control unit associated with the player in order to provide content most suitable to the viewer”s taste. Thus, much as a viewer of traditional television can adjust the color, brightness, tone and sound level of a broadcast, a viewer utilizing the present invention has controls that can adjust the viewing content to his or her particular tastes.

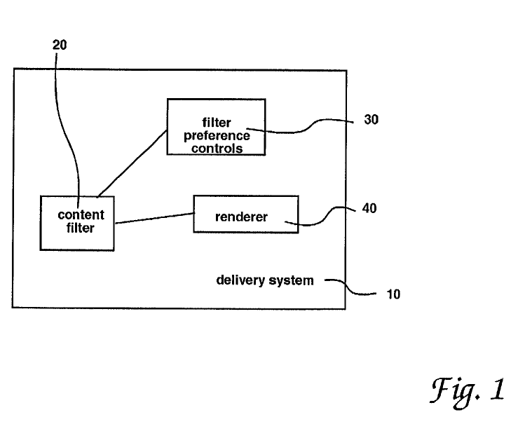

FIG. 1 shows a block diagram of one embodiment of the invention deployed as a delivery system 10. The delivery system 10 includes a content filter 20 that describes a plurality of adjustments to be made to media streams of a corresponding title; filter preference controls 30 for selecting, applying, and managing various filtering parameters of the content filter 20 during the viewing period; and, a renderer 40 for presenting the modified filtered media streams in a format to be experienced by a viewer. The preference controls 30 are interfaced with the content filter 20, so that the filter 20, when applied to the title, can reflect the selected preferences. The content filter 20 is authored such that when a set of parameters for the content filter 20 are selected by the filter preference controls 30, the selected aspects of the filter 20 are applied to a corresponding title and adjusted media streams are produced. The delivery system 10 includes a renderer 40 for presenting one or more adjusted multimedia streams, such as audio and video, to a viewer. In a typical environment, the media streams are audio and video and the renderer 40 is a television set or a home entertainment system.

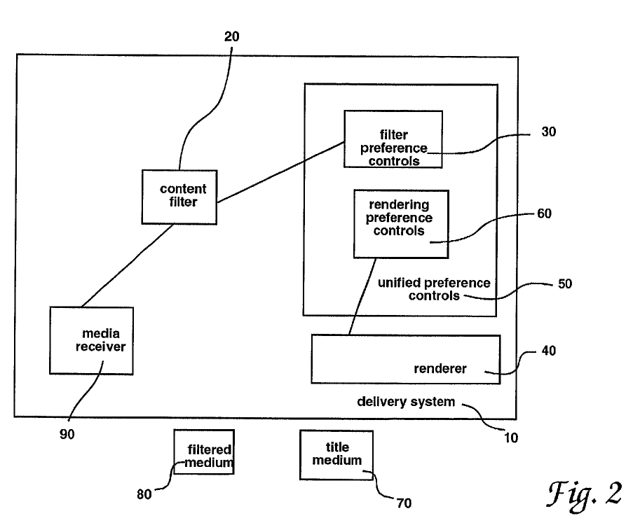

FIG. 2 shows a block diagram of an alternate embodiment. Referring to FIG. 2, the alternate embodiment has unified preference controls 50 that include both filter preference controls 30 and traditional rendering preference controls 60. Rendering preference controls 60 are typically traditional television viewing controls related to volume, channel selection, brightness, color saturation, and so forth. The unified preference control 50 is typically implemented in a single remote control unit, allowing content adjustments to be applied with the same ease as volume adjustments. FIG. 2 further illustrates additional elements that are typically used with the invention, including a title medium 70 which is typically a DVD disc or VHS tape; a filter medium 80 containing a copy of the content filter 20; a media receiver 90 capable of receiving and interpreting the title medium 70; and the filter medium 80.

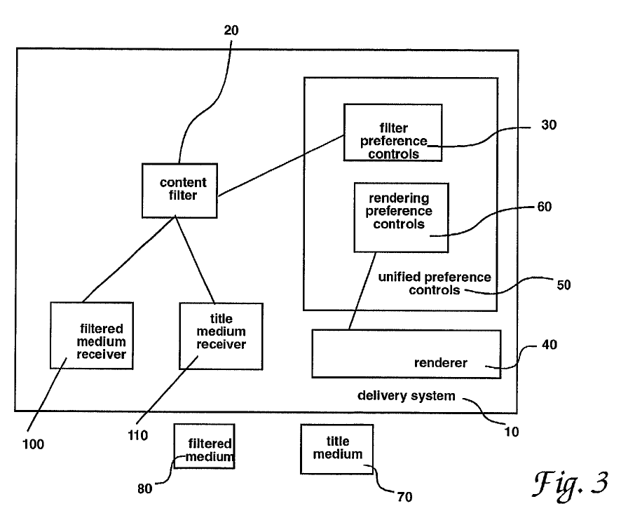

FIG. 3 is an alternate invention having separate medium receivers for the title medium and the content filter medium. Referring to FIG. 3, the delivery system 10 includes a filtered media receiver 100 for receiving the filter medium 80 and a separate title media receiver 110 for receiving the title medium 70.

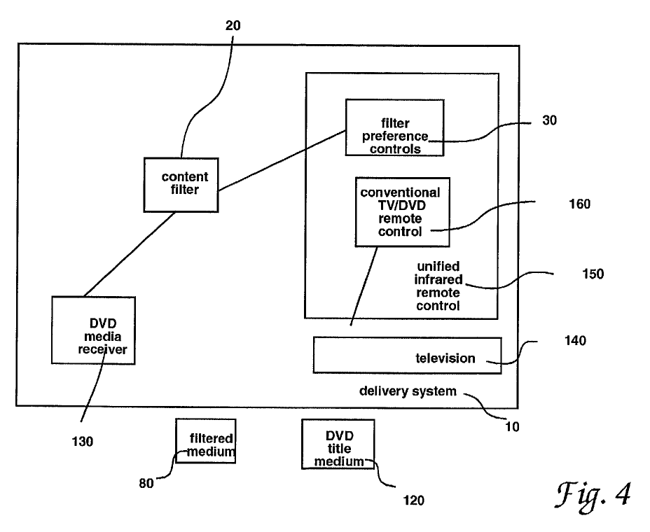

FIG. 4 illustrates the preferred embodiment of the invention. In the preferred embodiment, the delivery system 10 is an enhanced DVD player that plays filtered movies on a television set. The title medium to be filtered consists of movies distributed on a DVD medium. The filter controls are integrated with the standard DVD and TV controls in a single remote control unit. Referring to FIG. 4, the filter for a particular title is encoded on a DVD or CD-R medium 80. At viewing time, a user of the system 10 inserts the filter medium 80 into the DVD media receiver 130. A copy of the filter is stored in persistent memory (not shown) within the delivery system 10. Thus, the filter medium 80 is no longer needed for this viewing. Then the user inserts the DVD title medium 120 to be viewed and filtered into the DVD media receiver 130. In the embodiment of FIG. 4, the viewer has a unified infrared remote control 150 that controls the television, the DVD player, and the filter. The television and DVD player are controlled via a conventional DVD/TV remote control 160; the filter preference controls 30 are also programmed into the universal remote control unit 150. While the title is being viewed, default filter options are applied, but the user can adjust both the magnitude and the nature of the filtration as a filtered scene is being viewed. For example, the default filter settings might produce a small visual icon on the screen to alert the viewer that a scene is being filtered. At that point (depending on the characteristics of the particular filter), the user could cause a filter to produce a text box describing the exact nature of the filtered action, or could even elect to lift the filter.

Although the delivery system thus taught will provide useful results beyond those available in the prior art with a single, simple filter consisting of editing preferences selected by a single editor, better results are achieved when a master filter having multiple subfilters is created and deployed. A master filter consists of multiple subfilters, each of which reflects the tastes and editorial decisions of a single editor applying a particular editing strategy. Each editing strategy reflects an attempt to meet a particular class of foreseeable objections related to a particular class of viewers. For example, one editing strategy might be to remove references to deity that viewers of a particular religious faith would likely find objectionable. Another editing strategy might be to replace such references with alternate content rather than simply to delete them. Another editing strategy might be to remove sexual content altogether. Another editing strategy might be to be to remove or modify any content deemed to be inappropriate material for certain age groups.

By way of illustration, consider a scenario where the following editing strategies are defined.

Strategy 1-A: Remove references to deity that viewers of fundamentalist Christian faiths would likely find objectionable.

Strategy 1-B: Replace references to deity that viewers of fundamentalist Christian faiths would likely find objectionable with alternate inoffensive content.

Strategy 2-A: Remove all sexual content.

Strategy 2-B: Replace all sexual content with content deemed to be understandable by certain maturity levels but inoffensive to less mature viewers.

Strategy 2-C: Remove or replace gratuitous sexual content, but leave sexual content deemed crucial to the plot. For example, in a crime drama involving a rape case, the strategy would not remove dialogue discussing certain aspects of the rape, but would remove or soften specific graphic details, while preserving the essential plot.

Strategy 3-A: Remove all vulgar or profane dialogue.

Strategy 3-B: Replace vulgar or profane dialogue with slang words similar to the original words.

Strategy 3-C: Replace vulgar or profane dialogue with nomenclature that is dissimilar to the original words.

Strategy 4-A: Remove all violent content.

Strategy 4-B: Remove violent content directed toward specific targets, but leave content directed toward unspecified targets.

Strategy 4-B1: Remove violent content directed toward children.

Strategy 4-B2: Remove violent content directed toward women.

Strategy 4-B3: Remove violent content directed toward animals.

Note that each strategy (1, 2, 3, or 4) can be applied, if it is so desired, independently of the others. However, the subcategories labeled with a letter within each numbered category are mutually exclusive for a single rendition of a scene. For example, it is reasonable that a particular viewer might want all violent content removed, but allow vulgar or profane dialog to be unmodified. However, he can only apply either 4-A, or 4-B, but not both. If he selects 4-B, he must also select one or more of the corresponding subcategories (4-B1, 4-B2, and 4-B3).

Consider three different hypothetical editors, named Alice, Bill, and Cindy. Each attempts to apply one or more of the editing strategies to a particular media event. All available subfilters for a particular media event are combined into a single master filter to a particular media event. A particular viewer can then create a viewer-specific master filter based on his or her own preferences and his or her past experience with or confidence in a particular editor. To continue the illustration cited above, suppose a viewer named Val is of a particular fundamentalist Christian faith, and that Val knows that editor Cindy is of the same faith. For his or her default preferences, Val could specify criterion 1-B from Cindy (if available), and 1-A from Cindy if 1-B is unavailable for a particular scene, and 1-A from any other editor if the corresponding subfilter is not available from Cindy for a particular scene. Furthermore, Val could specify as his or her personal master filter preferences that Strategy 4-B1 and 4-B2 be applied, but not 4-B3, and he or she could also specify an editorial preference for Cindy.

Once Val has specified a personal master preference, then Val will have the further optional opportunity to review the actual subfilters available for a particular media event and to make choices specific to a particular viewing of a particular media event. For example, for a particular media event there may be no subfilters available from Cindy, at which time Val can review the subfilters that are available, and make alternate selections. Alternatively, Val can instruct the system to automatically choose the filters at viewing time, based on Val”s personal preferences as reported in Val”s master preference list. In the simplest case, viewer comfort levels can be defined, and default viewer comfort levels can be deployed, where little or no interaction is required from Val.

Additionally, Val may view a media event, with particular filtering criteria, and then decide to allow his or her children to view the event, with criteria that is stricter. Thus different renditions are available of the same media event. Since the filters are applied simultaneous to viewing making a persistent copy of the original media event is unnecessary.

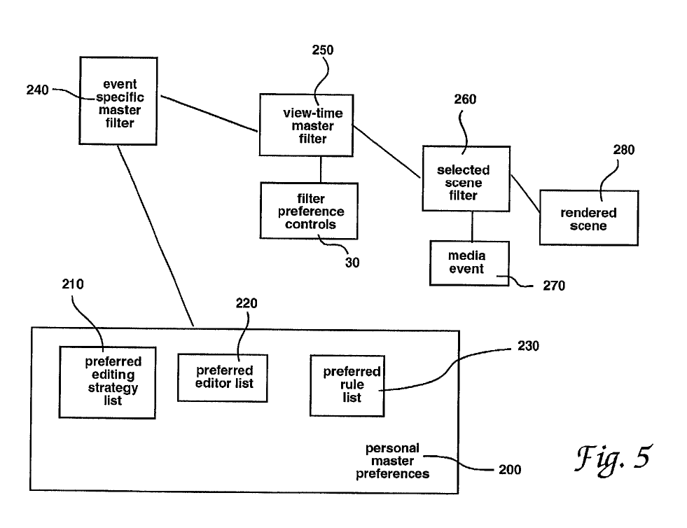

FIG. 5 illustrates generally how a master filter is deployed in the present invention and shows how the various elements of the invention are applied. Referring to FIG. 5, the personal master preferences 200 include a preferred editing strategy list 210, a preferred editor list 220, and a preferred rule list 230. The personal master preferences 200 are preferences associated with a particular viewer, independent of any media event. Thus a viewer can identify his or her preferences once, and the system can use the preferences to reduce or eliminate interaction from the user when a particular media event is to be viewed. The preferred editing strategy list 210 is a list of general categories of potentially offensive content that a particular viewer may generally wish to avoid. The preferred editor list 220 is a list of zero or more authors of filters that the viewer may select if the named editors have authored filters for a particular media event. The preferred rule list 230 is a list of logical rules to prescribe filtration preferences when preferred options are not available. For example, if a preferred editor has not produced a filter for a particular media event, then these rules can specify an alternate editor, whether or not a filter from any editor is acceptable, whether or not filters from multiple editors can be used, and so forth.

The event-specific master filter 240 is the set of all available subfilters from all filter authors available for a particular title. When a specific viewer is interested in viewing a specific media event, the personal master preferences 200 associated with that particular viewer are applied against all of the available subfilters identified in the event specific master filter 240 associated with the particular media event (title) of interest. Applying the personal master preferences 200 to the event-specific master filter 240 creates a view-time master filter 250. The preferred editing strategy list 210 and the preferred editor list 220 are also applied. Then, the preferred rule list 230 is applied to produce a view-time master filter 250. If the resulting filter 250 is not identified by the preferred rule list 230 as being appropriate for filtering, the viewer is queried to make specific choices applicable to the subfilters of the event-specific master filter 240 to produce the actual view-time master filter 250.

In an alternate embodiment, the master filter and movie title are deployed on the same medium, such as a DVD disc. Such an embodiment is envisioned in which the copyright owner chooses to include the present invention when distributing the media event.

Another embodiment involves deploying master filters to digital recordings of television programs. In this embodiment it is envisioned that fans of a particular television show will view and prepare content filters that are distributed over the Internet to viewers having their own recording of the particular episode. Another embodiment involves deploying a master filter against a musical recording primarily to filter offensive lyrical content.

The above embodiments and descriptions are presented for the purpose of illustration, not limitation. It is envisioned that the present invention is applicable in a wide range of media events, not limited to movies, television programs, music, or a variety of alternate media. The invention should only be limited by the claims as set forth below.

I claim:

1. A method for viewing a filtered media event in an environment having a delivery system comprising the steps of:
associating a content filter with the delivery system,
associating filter preference controls with the delivery system,
associating renderer with the delivery system,
wherein the filter preference controls are applied to the content filter and a media event to produce a filtered event, the altered event is rendered by the renderer for viewing.

2. The method of claim 1 further comprising the steps of:
associating unified preference controls with the delivery system,
associating rendering preference controls with the delivery system,
wherein rendering preference controls is applied to the renderer to suit viewer preferences, the unified preference controls further includes the filter preference controls and the rendering preference controls, the unified preference control can deploy visual, audio, and content preferences.

3. The method of claim 1 further comprising the steps of:
associating media receiver with the delivery system,
associating a filtered medium having a filter with the delivery system,
associating a title medium having a media event with the delivery system, wherein the delivery system further includes the media receiver, the media receiver is capable of reading the filtered medium to receive the filter, the media receiver is capable of reading the title medium to receive the media event.

4. The method of claim 1
wherein the media receiver further includes a filtered medium receiver and a title medium receiver, the filtered medium receiver is capable of reading the filtered medium to receive the filter, the title medium receiver is capable of reading the title medium to receive the media event.

5. The method of claim 1
wherein the unified preference control is an infrared television and digital versatile disc player remote control, the renders is a television, media receiver is a digital versatile disc media receiver, and the title medium is a digital versatile disc.

6. The method of claim 2 further comprising the steps of:
associating media receiver with the delivery system,
associating a filtered medium having a filter with the delivery system,
associating a title medium having a media event with the delivery system,
wherein the delivery system further includes the media receiver, the media receiver is capable of reading the filtered medium to receive the filter, the media receiver is capable of reading the title medium to receive the media event.

7. The method of claim 2
wherein the media receiver further includes a filtered medium receiver and a title medium receiver, the filtered medium receiver is capable of reading the filtered medium to receive the filter, the title medium receiver is capable of reading the title medium to receive the media event.

8. The method of claim 2
wherein the unified preference control is an infrared television and digital versatile disc player remote control, the renders is a television, media receiver is a digital versatile disc media receiver, and the title medium is a digital versatile disc.

9. The method of claim 6
wherein the media receiver further includes a filtered medium receiver and a title medium receiver, the filtered medium receiver is capable of reading the filtered medium to receive the filter, the title medium receiver is capable of reading the title medium to receive the media event.

10. The method of claim 6
wherein the unified preference control is an infrared television and digital versatile disc player remote control, the renders is a television, media receiver is a digital versatile disc media receiver, and the title medium is a digital versatile disc.

11. The method of claim 9
wherein the unified preference control is an infrared television and digital versatile disc player remote control, the renders is a television, media receiver is a digital versatile disc media receiver, and the title medium is a digital versatile disc.

12. A system for viewing a filtered media event in an environment having a delivery system comprising:
a content filter,
filter preference controls,
renderer,
wherein the filter preference controls are applied to the content filter and a media event to produce a filtered event, the altered event is rendered by the renderer for viewing.

13. The system of claim 12 further comprising:
unified preference controls,
rendering preference controls,
wherein rendering preference controls is applied to the renderer to suit viewer preferences, the unified preference controls further includes the filter preference controls and the rendering preference controls, the unified preference control can deploy visual, audio, and content preferences.

14. The system of claim 12 further comprising:
media receiver,
a filtered medium having a filter,
a title medium having a media event,
wherein the delivery system further includes the media receiver, the media receiver is capable of reading the filtered medium to receive the filter, the media receiver is capable of reading the title medium to receive the media event.

15. The system of claim 12
wherein the media receiver further includes a filtered medium receiver and a title medium receiver, the filtered medium receiver is capable of reading the filtered medium to receive the filter, the title medium receiver is capable of reading the title medium to receive the media event.

16. The system of claim 12
wherein the unified preference control is an infrared television and digital versatile disc player remote control, the renders is a television, media receiver is a digital versatile disc media receiver, and the title medium is a digital versatile disc.

17. The system of claim 13 further comprising:
media receiver,
a filtered medium having a filter,
a title medium having a media event,
wherein the delivery system further includes the media receiver, the media receiver is capable of reading the filtered medium to receive the filter, the media receiver is capable of reading the title medium to receive the media event.

18. The system of claim 13
wherein the media receiver further includes a filtered medium receiver and a title medium receiver, the filtered medium receiver is capable of reading the filtered medium to receive the filter, the title medium receiver is capable of reading the title medium to receive the media event.

19. The system of claim 13
wherein the unified preference control is an infrared television and digital versatile disc player remote control, the renders is a television, media receiver is a digital versatile disc media receiver, and the title medium is a digital versatile disc.

20. The system of claim 17
wherein the media receiver further includes a filtered medium receiver and a title medium receiver, the filtered medium receiver is capable of reading the filtered medium to receive the filter, the title medium receiver is capable of reading the title medium to receive the media event.

21. The system of claim 17
wherein the unified preference control is an infrared television and digital versatile disc player remote control, the renders is a television, media receiver is a digital versatile disc media receiver, and the title medium is a digital versatile disc.

22. The system of claim 20
wherein the unified preference control is an infrared television and digital versatile disc player remote control, the renders is a television, media receiver is a digital versatile disc media receiver, and the title medium is a digital versatile disc.

23. A method for building a content filter for filtering a media event in a viewing environment comprising the steps of:
associating personal master preferences with the viewing environment,
associating an event specific master filter with the viewing environment,
wherein the personal master preferences are logically combined with the event specific master to produce a view-time master filter.

24. The method of claim 23 further comprising the steps of:
associating filter preference controls with the viewing environment,
associating a scene of a media event with the viewing environment,
wherein the filter preference controls are use to select a scene filter corresponding to the scene of the media event, the scene filter is applied to the scene of the media event to produce a filtered scene, the filtered scene is rendered to a viewer.

25. A system for building a content filter for filtering a media event in a viewing environment comprising:
personal master preferences,
an event specific master filter,
wherein the personal master preferences are logically combined with the event specific master to produce a view-time master filter.

26. The system of claim 25 further comprising:
filter preference controls,
a scene of a media event,
wherein the filter preference controls are use to select a scene filter corresponding to the scene of the media event, the scene filter is applied to the scene of the media event to produce a filtered scene, the filtered scene is rendered to a viewer.

27. A method for producing a content filtered media event in a viewing environment comprising the steps of:
associating a viewing time with the viewing environment,
associating a first media event with the viewing environment,
associating a content filter with the viewing environment,
wherein the content filter is applied to the first media event at viewing time to produce a second media event.

28. The method of claim 27 further comprising the steps of:
associating a content preference control with the viewing environment,
the content filter further including filter parameters, the content preference control further including an adjustment for the filter parameters,
wherein filter parameters are adjusted at viewing time.

29. The method of claim 27
wherein the first media event is a commercial movie distributed on media intended for home viewing.

30. The method of claim 27
wherein the content filter targets potentially offensive content.

31. The method of claim 27
wherein the content filter targets content unsuitable for handicapped viewers.

32. The method of claim 28
wherein the first media event is a commercial movie distributed on media intended for home viewing.

33. The method of claim 28
wherein the content filter targets potentially offensive content.

34. The method of claim 28
wherein the content filter targets content unsuitable for handicapped viewers.

35. The method of claim 32
wherein the content filter targets potentially offensive content.

36. The method of claim 32
wherein the content filter targets content unsuitable for handicapped viewers.

37. A system for producing a content filtered media event in a viewing environment comprising:
a viewing time,
a first media event,
a content filter,
wherein the content filter is applied to the first media event at viewing time to produce a second media event.

38. The system of claim 37 further comprising:
a content preference control, the content filter further including filter parameters, the content preference control further including an adjustment for the filter parameters,
wherein filter parameters are adjusted at viewing time.

39. The system of claim 37
wherein the first media event is a commercial movie distributed on media intended for home viewing.

40. The system of claim 37
wherein the content filter targets potentially offensive content.

41. The system of claim 37
wherein the content filter targets content unsuitable for handicapped viewers.

42. The system of claim 38
wherein the first media event is a commercial movie distributed on media intended for home viewing.

43. The system of claim 38
wherein the content filter targets potentially offensive content.

44. The system of claim 38
wherein the content filter targets content unsuitable for handicapped viewers.

45. The system of claim 42
wherein the content filter targets potentially offensive content.

46. The system of claim 42
wherein the content filter targets content unsuitable for handicapped viewers.
